(19) United States
(12) Patent Application Publication
(10) Pub. No.: US 2026/0113164 A1
(43) Pub. Date: Apr. 23, 2026

(54) TRANSMISSION CONFIGURATION INDICATOR STATE INDICATIONS FOR COHERENT JOINT TRANSMISSION

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/113,279

(22) PCT Filed: Nov. 23, 2022
(86) PCT No.: PCT/CN2022/133607

§ 371 Date: Mar. 19, 2025

(51) Int. Cl. H04L 5/00; H04W 72/232

(52) U.S. Cl. CPC H04L 5/0053; H04W 72/232

(57) ABSTRACT

Various aspects of the present disclosure generally relate to wireless communication. In some aspects, a user equipment (UE) may receive one or more unified transmission configuration indicator (TCI) state indications for coherent joint transmission operations with more than two unified TCI states per layer of a physical downlink shared channel (PDSCH), wherein the UE is configured for a single frequency network operation for a physical downlink control channel (PDCCH) that applies two TCI states to a control resource set that receives the PDCCH. The UE may select one or more unified TCI states for one or more physical downlink channel communications based at least in part on the one or more unified TCI state indications. The UE may receive the one or more physical downlink channel communications using the selected one or more unified TCI states. Numerous other aspects are described.

### FIELD OF THE DISCLOSURE

Aspects of the present disclosure generally relate to wireless communication and to techniques and apparatuses for transmission configuration indicator state indications for coherent joint transmission.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving one or more unified transmission configuration indicator (TCI) state indications for coherent joint transmission (CJT) operations with more than two unified TCI states per layer of a physical downlink shared channel (PDSCH), where the UE is configured for a single frequency network (SFN) operation for a physical downlink control channel (PDCCH) that applies two TCI states to a control resource set (CORESET) that receives the PDCCH. The method may include selecting one or more unified TCI states for one or more physical downlink channel communications based at least in part on the one or more unified TCI state indications. The method may include receiving the one or more physical downlink channel communications using the selected one or more unified TCI states.

Some aspects described herein relate to a method of wireless communication performed by a network entity. The method may include transmitting one or more unified TCI state indications for CJT operations with more than two unified TCI states per layer of a PDSCH, where the one or more unified TCI state indications are associated with a configuration for an SFN operation for a PDCCH that applies two TCIs to a CORESET that receives the PDCCH. The method may include selecting one or more unified TCI states for one or more physical downlink channel communications based at least in part on the one or more unified TCI state indications. The method may include transmitting one or more physical downlink channel communications using the selected one or more unified TCI states.

Some aspects described herein relate to a method of wireless communication performed by a UE. The method may include receiving a dynamic switching indication that indicates a switch to a single transmit receive point (TRP) operation or a multiple TRP operation for CJT operations with more than two unified TCI states per layer of a PDSCH, where the UE is configured for an SFN operation for a PDCCH that applies two TCIs to a CORESET that receives the PDCCH. The method may include switching to the single TRP operation or the multiple TRP operation based at least in part on the dynamic switching indication.

Some aspects described herein relate to a method of wireless communication performed by a network entity. The method may include transmitting a dynamic switching indication that indicates a switch to a single TRP operation or a multiple TRP operation for CJT operations with more than two unified TCI states per layer of a PDSCH, where the dynamic switching indication is associated with a configuration for an SFN operation for a PDCCH that applies two TCIs to a CORESET that receives the PDCCH. The method may include switching to the single TRP operation or the multiple TRP operation based at least in part on the dynamic switching indication.

Some aspects described herein relate to a UE for wireless communication. The UE may include a memory and one or more processors coupled to the memory. The one or more processors may be configured to receive one or more unified TCI state indications for CJT operations with more than two unified TCI states per layer of a PDSCH, where the UE is configured for an SFN operation for a PDCCH that applies two TCI states to a CORESET that receives the PDCCH. The one or more processors may be configured to select one or more unified TCI states for one or more physical downlink channel communications based at least in part on the one or more unified TCI state indications. The one or more processors may be configured to receive the one or more physical downlink channel communications using the selected one or more unified TCI states.

Some aspects described herein relate to a network entity for wireless communication. The network entity may include a memory and one or more processors coupled to the memory. The one or more processors may be configured to transmit one or more unified TCI state indications for CJT operations with more than two unified TCI states per layer of a PDSCH, where the one or more unified TCI state indications are associated with a configuration for an SFN operation for a PDCCH that applies two TCIs to a CORESET that receives the PDCCH. The one or more processors may be configured to select one or more unified TCI states for one or more physical downlink channel communications based at least in part on the one or more unified TCI state indications. The one or more processors may be configured to transmit one or more physical downlink channel communications using the selected one or more unified TCI states.

Some aspects described herein relate to a UE for wireless communication. The UE may include a memory and one or more processors coupled to the memory. The one or more processors may be configured to receive a dynamic switching indication that indicates a switch to a single TRP operation or a multiple TRP operation for CJT operations with more than two unified TCI states per layer of a PDSCH, where the UE is configured for an SFN operation for a PDCCH that applies two TCIs to a CORESET that receives the PDCCH. The one or more processors may be configured to switch to the single TRP operation or the multiple TRP operation based at least in part on the dynamic switching indication.

Some aspects described herein relate to a network entity for wireless communication. The network entity may include a memory and one or more processors coupled to the memory. The one or more processors may be configured to transmit a dynamic switching indication that indicates a switch to a single TRP operation or a multiple TRP operation for CJT operations with more than two unified TCI states per layer of a PDSCH, where the dynamic switching indication is associated with a configuration for an SFN operation for a PDCCH that applies two TCIs to a CORESET that receives the PDCCH. The one or more processors may be configured to switch to the single TRP operation or the multiple TRP operation based at least in part on the dynamic switching indication.

Some aspects described herein relate to a non-transitory computer-readable medium that stores a set of instructions for wireless communication by a UE. The set of instructions, when executed by one or more processors of the UE, may cause the UE to receive one or more unified TCI state indications for CJT operations with more than two unified TCI states per layer of a PDSCH, where the UE is configured for an SFN operation for a PDCCH that applies two TCI states to a CORESET that receives the PDCCH. The set of instructions, when executed by one or more processors of the UE, may cause the UE to select one or more unified TCI states for one or more physical downlink channel communications based at least in part on the one or more unified TCI state indications. The set of instructions, when executed by one or more processors of the UE, may cause the UE to receive the one or more physical downlink channel communications using the selected one or more unified TCI states.

Some aspects described herein relate to a non-transitory computer-readable medium that stores a set of instructions for wireless communication by a network entity. The set of instructions, when executed by one or more processors of the network entity, may cause the network entity to transmit one or more unified TCI state indications for CJT operations with more than two unified TCI states per layer of a PDSCH, where the one or more unified TCI state indications are associated with a configuration for an SFN operation for a PDCCH that applies two TCIs to a CORESET that receives the PDCCH. The set of instructions, when executed by one or more processors of the network entity, may cause the network entity to select one or more unified TCI states for one or more physical downlink channel communications based at least in part on the one or more unified TCI state indications. The set of instructions, when executed by one or more processors of the network entity, may cause the network entity to transmit one or more physical downlink channel communications using the selected one or more unified TCI states.

Some aspects described herein relate to a non-transitory computer-readable medium that stores a set of instructions for wireless communication by a UE. The set of instructions, when executed by one or more processors of the UE, may cause the UE to receive a dynamic switching indication that indicates a switch to a single TRP operation or a multiple TRP operation for CJT operations with more than two unified TCI states per layer of a PDSCH, where the UE is configured for an SFN operation for a PDCCH that applies two TCIs to a CORESET that receives the PDCCH. The set of instructions, when executed by one or more processors of the UE, may cause the UE to switch to the single TRP operation or the multiple TRP operation based at least in part on the dynamic switching indication.

Some aspects described herein relate to a non-transitory computer-readable medium that stores a set of instructions for wireless communication by a network entity. The set of instructions, when executed by one or more processors of the network entity, may cause the network entity to transmit a dynamic switching indication that indicates a switch to a single TRP operation or a multiple TRP operation for CJT operations with more than two unified TCI states per layer of a PDSCH, where the dynamic switching indication is associated with a configuration for an SFN operation for a PDCCH that applies two TCIs to a CORESET that receives the PDCCH. The set of instructions, when executed by one or more processors of the network entity, may cause the network entity to switch to the single TRP operation or the multiple TRP operation based at least in part on the dynamic switching indication.

Some aspects described herein relate to an apparatus for wireless communication. The apparatus may include means for receiving one or more unified TCI state indications for CJT operations with more than two unified TCI states per layer of a PDSCH, where the apparatus is configured for an SFN operation for a PDCCH that applies two TCI states to a CORESET that receives the PDCCH. The apparatus may include means for selecting one or more unified TCI states for one or more physical downlink channel communications based at least in part on the one or more unified TCI state indications. The apparatus may include means for receiving the one or more physical downlink channel communications using the selected one or more unified TCI states.

Some aspects described herein relate to an apparatus for wireless communication. The apparatus may include means for transmitting one or more unified TCI state indications for CJT operations with more than two unified TCI states per layer of a PDSCH, where the one or more unified TCI state indications are associated with a configuration for an SFN operation for a PDCCH that applies two TCIs to a CORESET that receives the PDCCH. The apparatus may include means for selecting one or more unified TCI states for one or more physical downlink channel communications based at least in part on the one or more unified TCI state indications. The apparatus may include means for transmitting one or more physical downlink channel communications using the selected one or more unified TCI states.

Some aspects described herein relate to an apparatus for wireless communication. The apparatus may include means for receiving a dynamic switching indication that indicates a switch to a single TRP operation or a multiple TRP operation for CJT operations with more than two unified TCI states per layer of a PDSCH, where the UE is configured for an SFN operation for a PDCCH that applies two TCIs to a CORESET that receives the PDCCH. The apparatus may include means for switching to the single TRP operation or the multiple TRP operation based at least in part on the dynamic switching indication.

Some aspects described herein relate to an apparatus for wireless communication. The apparatus may include means for transmitting a dynamic switching indication that indicates a switch to a single TRP operation or a multiple TRP operation for CJT operations with more than two unified TCI states per layer of a PDSCH, where the dynamic switching indication is associated with a configuration for an SFN operation for a PDCCH that applies two TCIs to a CORESET that receives the PDCCH. The apparatus may include means for switching to the single TRP operation or the multiple TRP operation based at least in part on the dynamic switching indication.

Aspects generally include a method, apparatus, system, computer program product, non-transitory computer-readable medium, UE, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity (e.g., base station) in communication with a user equipment (UE) in a wireless network, in accordance with the present disclosure.

FIG. 3 is a diagram illustrating an example of a disaggregated base station, in accordance with the present disclosure.

FIG. 4 illustrates an example logical architecture of a distributed random access network, in accordance with the present disclosure.

FIG. 5 is a diagram illustrating an example of multiple transmit receive point (TRP) communication, in accordance with the present disclosure.

FIG. 6 is a diagram illustrating examples of beam management procedures, in accordance with the present disclosure.

FIG. 7 is a diagram illustrating an example of using beams for communications between a network entity and a UE, in accordance with the present disclosure.

FIG. 8 is a diagram illustrating an example of coherent joint transmission (CJT) and non-CJT for multiple TRPs, in accordance with the present disclosure.

FIG. 9 is a diagram illustrating an example of CJT for a physical downlink shared channel, in accordance with the present disclosure.

FIG. 10 is a diagram illustrating an example of indicating transmission configuration indicator states for CJT with multiple TRPs, in accordance with the present disclosure.

FIG. 11 is a diagram illustrating an example of indicating a switch to a single TRP operation or a multi-TRP operation, in accordance with the present disclosure.

FIG. 12 is a diagram illustrating an example process performed, for example, by a UE, in accordance with the present disclosure.

FIG. 13 is a diagram illustrating an example process performed, for example, by a network entity, in accordance with the present disclosure.

FIG. 14 is a diagram illustrating an example process performed, for example, by a UE, in accordance with the present disclosure.

FIG. 15 is a diagram illustrating an example process performed, for example, by a network entity, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

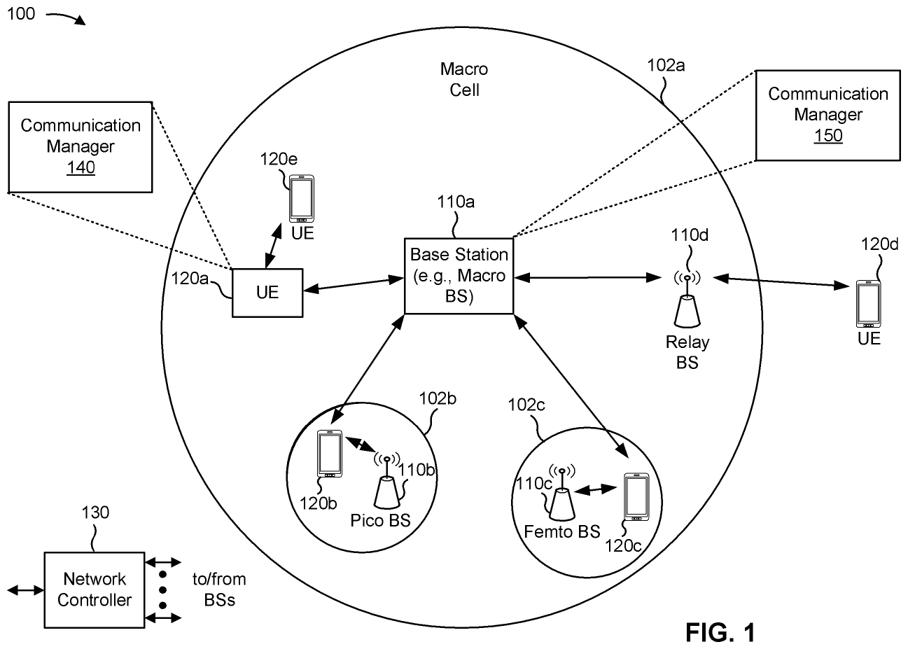

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120e). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmit receive point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the terms “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station” or “network entity” may refer to one device configured to perform one or more functions, such as those described herein in connection with the base station 110. In some aspects, the terms “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the terms “base station” or “network entity” may refer to any one or more of those different devices. In some aspects, the terms “base station” or “network entity” may refer to one or more virtual base stations and/or one or more virtual base station functions. For example, in some aspects, two or more base station functions may be instantiated on a single device. In some aspects, the terms “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive one or more unified transmission configuration indicator (TCI) state indications for coherent joint transmission (CJT) operations with more than two unified TCI states per layer of a physical downlink shared channel (PDSCH), where the UE is configured for a single frequency network (SFN) operation for a physical downlink control channel (PDCCH) that applies two TCI states to a control resource set (CORESET) that receives the PDCCH. The communication manager 140 may select one or more unified TCI states for one or more physical downlink channel communications based at least in part on the one or more unified TCI state indications. The communication manager 140 may receive the one or more physical downlink channel communications using the selected one or more unified TCI states.

In some aspects, the communication manager 140 may receive a dynamic switching indication that indicates a switch to a single TRP operation or a multiple TRP operation for CJT operations with more than two unified TCI states per layer of a PDSCH, where the UE is configured for an SFN operation for a PDCCH that applies two TCIs to a CORESET that receives the PDCCH. The communication manager 140 may switch to the single TRP operation or the multiple TRP operation based at least in part on the dynamic switching indication. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit one or more unified TCI state indications for CJT operations with more than two unified TCI states per layer of a PDSCH, where the one or more unified TCI state indications are associated with a configuration for an SFN operation for a PDCCH that applies two TCIs to a CORESET that receives the PDCCH. The communication manager 150 may select one or more unified TCI states for one or more physical downlink channel communications based at least in part on the one or more unified TCI state indications. The communication manager 150 may transmit one or more physical downlink channel communications using the selected one or more unified TCI states.

In some aspects, the communication manager 150 may transmit a dynamic switching indication that indicates a switch to a single TRP operation or a multiple TRP operation for CJT operations with more than two unified TCI states per layer of a PDSCH, where the dynamic switching indication is associated with a configuration for an SFN operation for a PDCCH that applies two TCIs to a CORESET that receives the PDCCH. The communication manager 150 may switch to the single TRP operation or the multiple TRP operation based at least in part on the dynamic switching indication. Additionally, or alternatively, the communication manager 150 may perform one or more other operations described herein.

As indicated above, FIG. 1 is provided as an example. Other examples may differ from what is described with regard to FIG. 1.

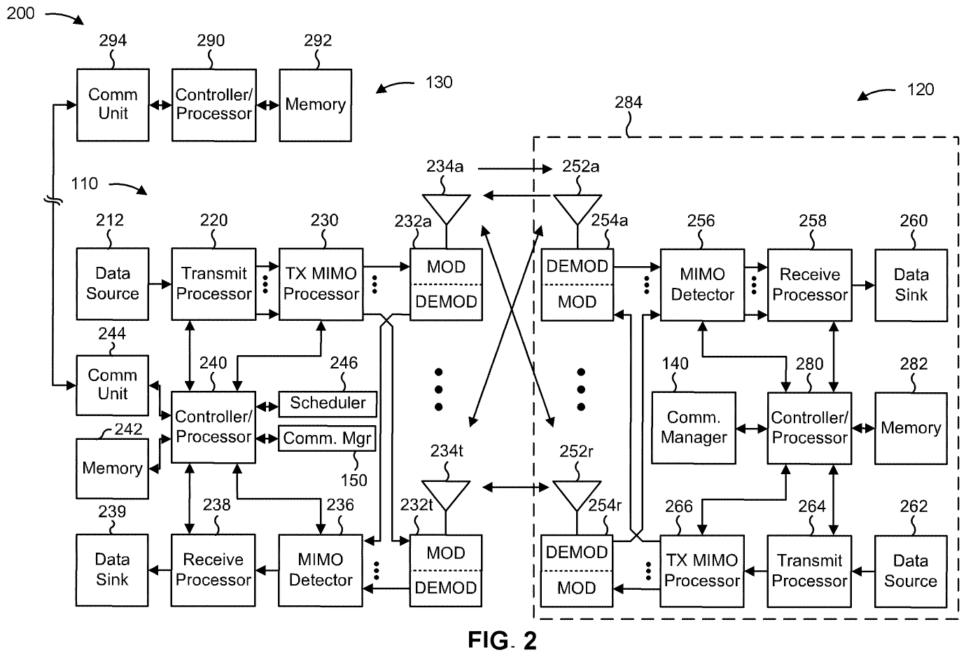

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., 7 modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

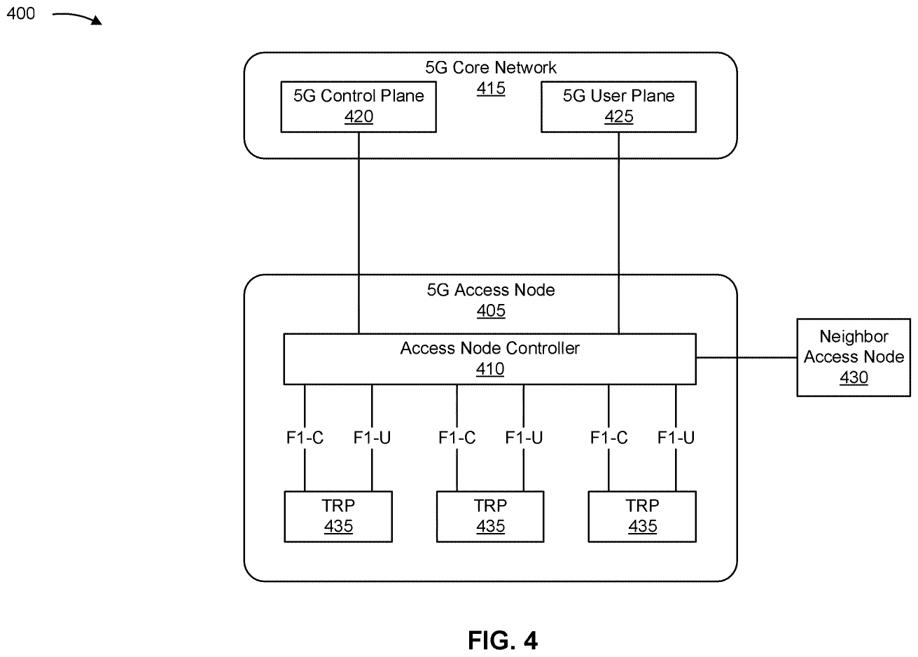

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-17).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-17).

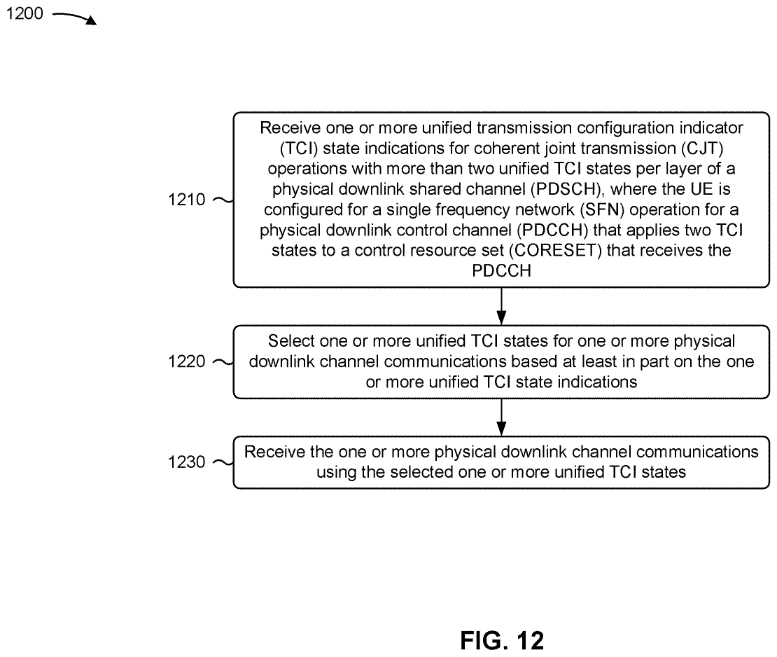

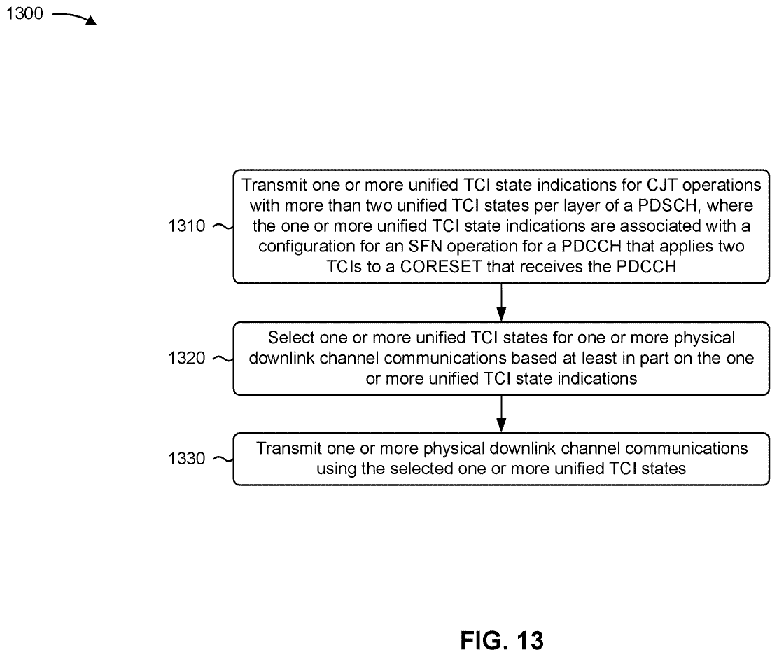

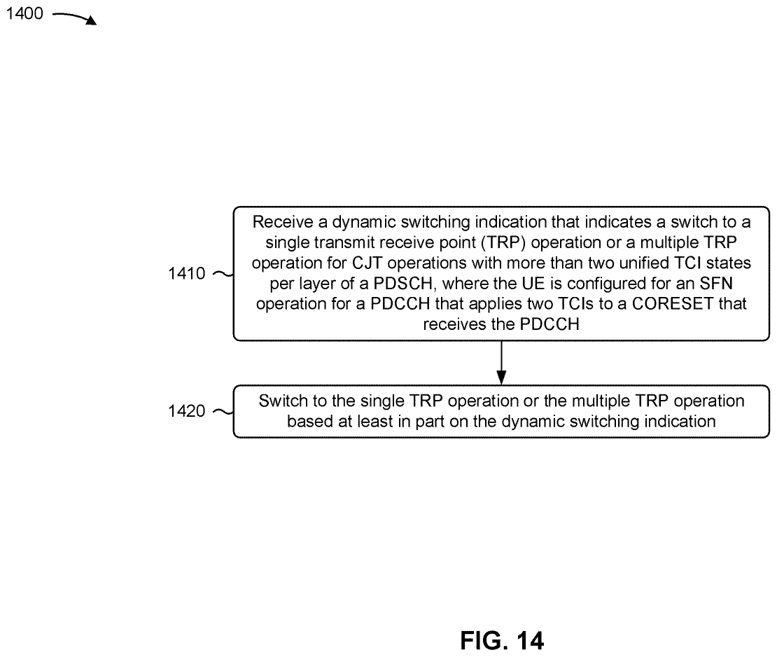

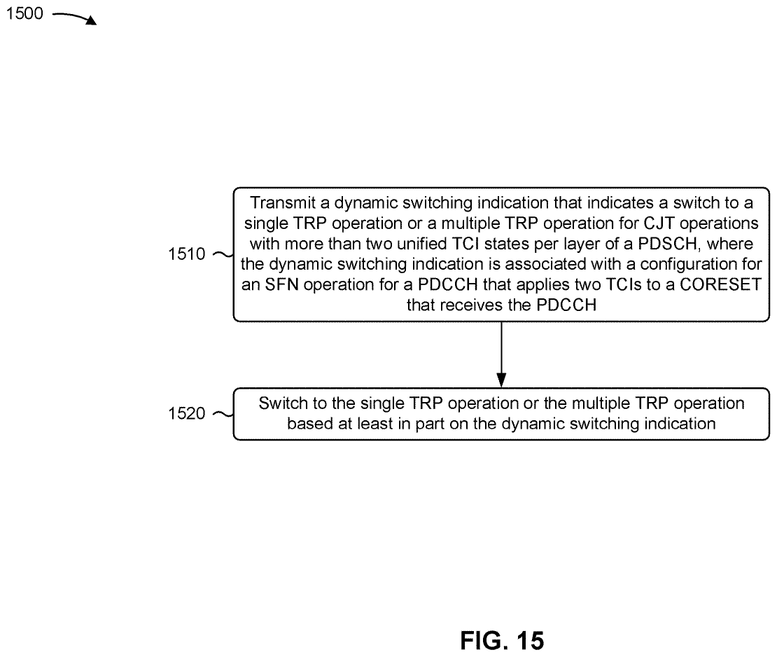

A controller/processor of a network entity (e.g., the controller/processor 240 of the base station 110), the controller/processor 280 of the UE 120, and/or any other component(s) of FIG. 2 may perform one or more techniques associated with unified TCI state indications for CJT, as described in more detail elsewhere herein. For example, the controller/processor 240 of the base station 110, the controller/processor 280 of the UE 120, and/or any other component(s) of FIG. 2 may perform or direct operations of, for example, process 1200 of FIG. 12, process 1300 of FIG. 13, process 1400 of FIG. 14, process 1500 of FIG. 15, and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1200 of FIG. 12, process 1300 of FIG. 13, process 1400 of FIG. 14, process 1500 of FIG. 15, and/or other processes as described herein. In some examples, executing instructions may include running the instructions, converting the instructions, compiling the instructions, and/or interpreting the instructions, among other examples.

In some aspects, a UE (e.g., UE 120) includes means for receiving one or more unified TCI state indications for CJT operations with more than two unified TCI states per layer of a PDSCH, where the UE is configured for an SFN operation for a PDCCH that applies two TCI states to a CORESET that receives the PDCCH; means for selecting one or more unified TCI states for one or more physical downlink channel communications based at least in part on the one or more unified TCI state indications; and/or means for receiving the one or more physical downlink channel communications using the selected one or more unified TCI states. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a UE (e.g., UE 120) includes means for receiving a dynamic switching indication that indicates a switch to a single TRP operation or a multiple TRP operation for CJT operations with more than two unified TCI states per layer of a PDSCH, where the UE is configured for an SFN operation for a PDCCH that applies two TCIs to a CORESET that receives the PDCCH; and/or means for switching to the single TRP operation or the multiple TRP operation based at least in part on the dynamic switching indication.

In some aspects, a network entity (e.g., base station 110) includes means for transmitting one or more unified TCI state indications for CJT operations with more than two unified TCI states per layer of a PDSCH, where the one or more unified TCI state indications are associated with a configuration for an SFN operation for a PDCCH that applies two TCIs to a CORESET that receives the PDCCH; means for selecting one or more unified TCI states for one or more physical downlink channel communications based at least in part on the one or more unified TCI state indications; and/or means for transmitting one or more physical downlink channel communications using the selected one or more unified TCI states. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, a network entity (e.g., base station 110) includes means for transmitting a dynamic switching indication that indicates a switch to a single TRP operation or a multiple TRP operation for CJT operations with more than two unified TCI states per layer of a PDSCH, where the dynamic switching indication is associated with a configuration for an SFN operation for a PDCCH that applies two TCIs to a CORESET that receives the PDCCH; and/or means for switching to the single TRP operation or the multiple TRP operation based at least in part on the dynamic switching indication.

As indicated above, FIG. 2 is provided as an example. Other examples may differ from what is described with regard to FIG. 2.

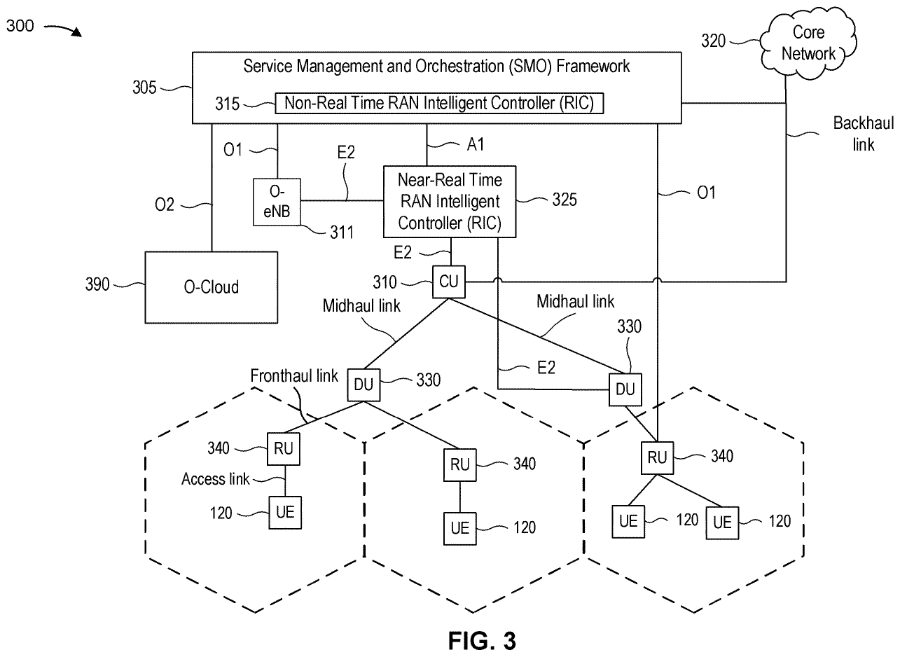

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU).

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)).

Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUS (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above, FIG. 3 is provided as an example. Other examples may differ from what is described with regard to FIG. 3.

FIG. 4 illustrates an example logical architecture of a distributed RAN 400, in accordance with the present disclosure.

A 5G access node 405 may include an access node controller 410. The access node controller 410 may be a CU of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a DU of the distributed RAN 400. In some aspects, a TRP 435 may correspond to a base station 110 described above in connection with FIG. 1. For example, different TRPs 435 may be included in different base stations 110. Additionally, or alternatively, multiple TRPs 435 may be included in a single base station 110. In some aspects, a base station 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a PDCP layer, an RLC layer, and/or a MAC layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different quasi-co-location (QCL) relationships (e.g., different spatial parameters, different TCI states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

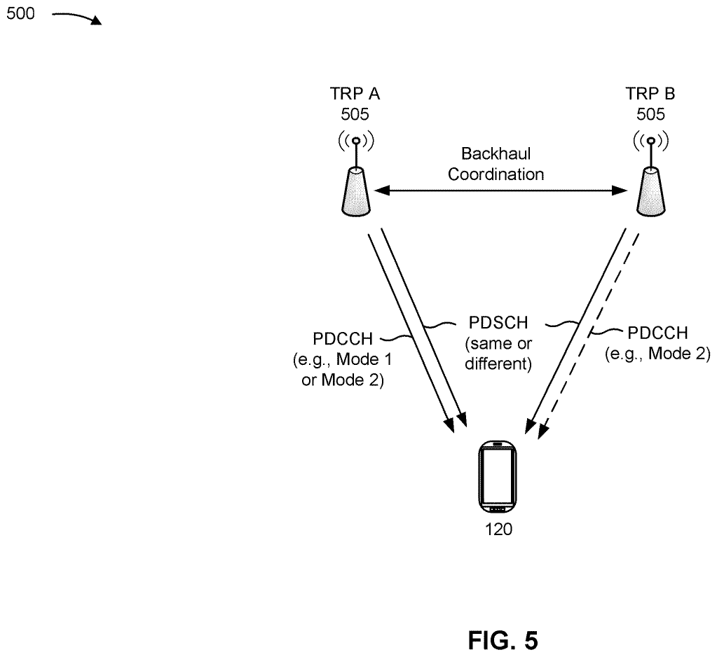

FIG. 5 is a diagram illustrating an example 500 of multiple TRP (multi-TRP) communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same base station 110 (e.g., when the TRPs 505 are different antenna arrays or panels of the same base station 110), and may have a larger delay and/or lower capacity (as compared to co-location) when the TRPs 505 are located at different base stations 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single PDCCH may be used to schedule downlink data communications for a single PDSCH. In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 5 is provided as an example. Other examples may differ from what is described with respect to FIG. 5.

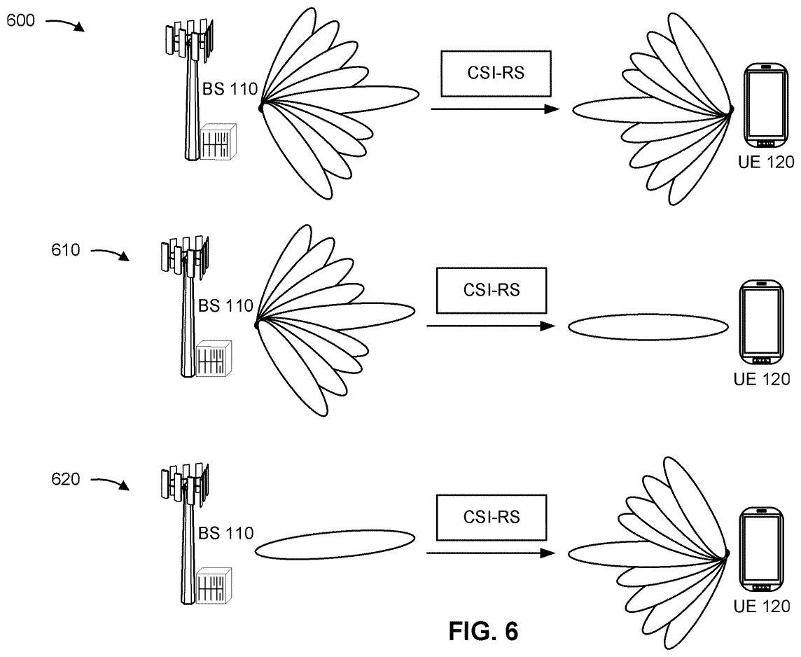

FIG. 6 is a diagram illustrating examples 600, 610, and 620 of beam management procedures, in accordance with the present disclosure. As shown in FIG. 6, examples 600, 610, and 620 include a UE 120 in communication with a network entity (e.g., base station 110) in a wireless network (e.g., wireless network 100). However, the devices shown in FIG. 6 are provided as examples, and the wireless network may support communication and beam management between other devices (e.g., between a UE 120 and a base station 110 or TRP, between a mobile termination node and a control node, between an IAB child node and an IAB parent node, and/or between a scheduled node and a scheduling node). In some aspects, the UE 120 and the base station 110 may be in a connected state (e.g., an RRC connected state).

As shown in FIG. 6, example 600 may include a base station 110 and a UE 120 communicating to perform beam management using channel state information (CSI) reference signals (CSI-RSs). Example 600 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 6 and example 600, CSI-RSs may be configured to be transmitted from the base station 110 to the UE 120. The CSI-RSs may be configured to be periodic (e.g., using RRC signaling), semi-persistent (e.g., using MAC control element (MAC CE) signaling), and/or aperiodic (e.g., using DCI).

The first beam management procedure may include the base station 110 performing beam sweeping over multiple transmit (Tx) beams. The base station 110 may transmit a CSI-RS using each transmit beam for beam management. To enable the UE 120 to perform receive (Rx) beam sweeping, the base station may use a transmit beam to transmit (e.g., with repetitions) each CSI-RS at multiple times within the same RS resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the first beam management procedure may enable the UE 120 to measure a CSI-RS on different transmit beams using different receive beams to support selection of base station 110 transmit beams/UE 120 receive beam(s) beam pair(s). The UE 120 may report the measurements to the base station 110 to enable the base station 110 to select one or more beam pair(s) for communication between the base station 110 and the UE 120. While example 600 has been described in connection with CSI-RSs, the first beam management process may also use synchronization signal blocks (SSBs) for beam management in a similar manner as described above.

As shown in FIG. 6, example 610 may include a base station 110 and a UE 120 communicating to perform beam management using CSI-RSs. Example 610 depicts a second beam management procedure (e.g., P2 CSI-RS beam management). The second beam management procedure may be referred to as a beam refinement procedure, a base station beam refinement procedure, a TRP beam refinement procedure, and/or a transmit beam refinement procedure. As shown in FIG. 6 and example 610, CSI-RSs may be configured to be transmitted from the base station 110 to the UE 120. The CSI-RSs may be configured to be aperiodic (e.g., using DCI). The second beam management procedure may include the base station 110 performing beam sweeping over one or more transmit beams. The one or more transmit beams may be a subset of all transmit beams associated with the base station 110 (e.g., determined based at least in part on measurements reported by the UE 120 in connection with the first beam management procedure). The base station 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the base station 110 to select a best transmit beam based at least in part on measurements of the CSI-RSs (e.g., measured by the UE 120 using the single receive beam) reported by the UE 120.

As shown in FIG. 6, example 620 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 6 and example 620, one or more CSI-RSs may be configured to be transmitted from the base station 110 to the UE 120. The CSI-RSs may be configured to be aperiodic (e.g., using DCI). The third beam management process may include the base station 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the base station may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the base station 110 and/or the UE 120 to select a best receive beam based at least in part on reported measurements received from the UE 120 (e.g., of the CSI-RS of the transmit beam using the one or more receive beams).

As indicated above, FIG. 6 is provided as an example of beam management procedures. Other examples of beam management procedures may differ from what is described with respect to FIG. 6. For example, the UE 120 and the base station 110 may perform the third beam management procedure before performing the second beam management procedure, and/or the UE 120 and the base station 110 may perform a similar beam management procedure to select a UE transmit beam.

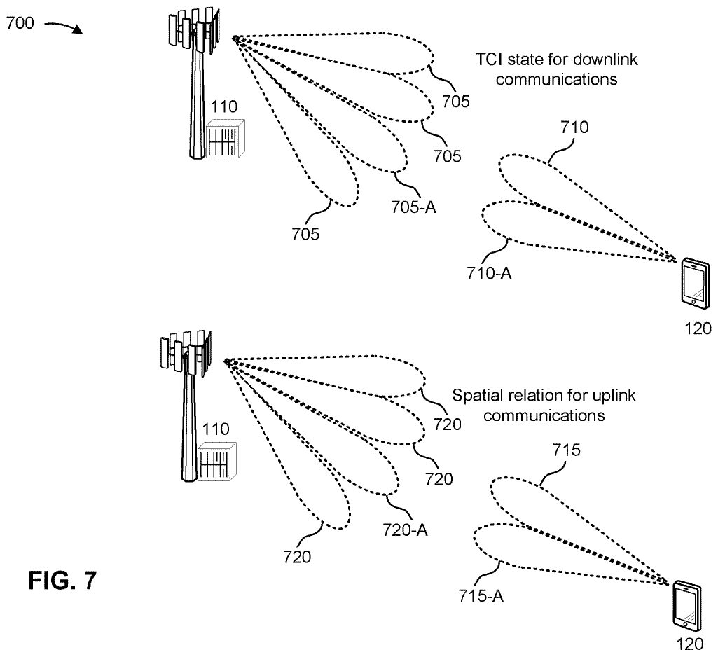

FIG. 7 is a diagram illustrating an example 700 of using beams for communications between a network entity (e.g., base station 110) and a UE (e.g., UE 120), in accordance with the present disclosure. As shown in FIG. 7, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional network entity transmit beam (e.g., a BS transmit beam), and the UE 120 may receive the transmission using a directional UE receive beam. Each transmit beam may have an associated beam ID, beam direction, or beam symbols, among other examples. The base station 110 may transmit downlink communications via one or more transmit beams 705.

The UE 120 may attempt to receive downlink transmissions via one or more UE receive beams 710, which may be configured using different beamforming parameters at receive circuitry of the UE 120. The UE 120 may identify a particular transmit beam 705, shown as transmit beam 705-A, and a particular UE receive beam 710, shown as UE receive beam 710-A, that provide relatively favorable performance (for example, that have a best channel quality of the different measured combinations of transmit beams 705 and UE receive beams 710). In some examples, the UE 120 may transmit an indication of which transmit beam 705 is identified by the UE 120 as a preferred transmit beam, which the base station 110 may select for transmissions to the UE 120. The UE 120 may thus attain and maintain a beam pair link (BPL) with the base station 110 for downlink communications (for example, a combination of the transmit beam 705-A and the UE receive beam 710-A), which may be further refined and maintained in accordance with one or more established beam refinement procedures.

A downlink beam, such as a transmit beam 705 or a UE receive beam 710, may be associated with a transmission configuration indication (TCI) state. A TCI state may indicate a directionality or a characteristic of the downlink beam, such as one or more quasi-co-location (QCL) properties of the downlink beam. A QCL property may include, for example, a Doppler shift, a Doppler spread, an average delay, a delay spread, or spatial receive parameters, among other examples. In some examples, each transmit beam 705 may be associated with a synchronization signal block (SSB), and the UE 120 may indicate a preferred transmit beam 705 by transmitting uplink transmissions in resources of the SSB that are associated with the preferred transmit beam 705. A particular SSB may have an associated TCI state (for example, for an antenna port or for beamforming). The base station 110 may, in some examples, indicate a downlink transmit beam 705 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 710 at the UE 120. Thus, the UE 120 may select a corresponding UE receive beam 710 from a set of BPLs based at least in part on the base station 110 indicating a transmit beam 705 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a PDSCH. The set of activated TCI states for downlink control channel communications may correspond to beams that the base station 110 may use for downlink transmission on a PDCCH or in a CORESET. The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as an RRC message.

Similarly, for uplink communications, the UE 120 may transmit in the direction of the base station 110 using a directional UE transmit beam, and the base station 110 may receive the transmission using a directional receive beam. Each UE transmit beam may have an associated beam ID, beam direction, or beam symbols, among other examples. The UE 120 may transmit uplink communications via one or more UE transmit beams 715.

The base station 110 may receive uplink transmissions via one or more receive beams 720 (e.g., BS receive beams). The base station 110 may identify a particular UE transmit beam 715, shown as UE transmit beam 715-A, and a particular receive beam 720, shown as receive beam 720-A, that provide relatively favorable performance (for example, that have a best channel quality of the different measured combinations of UE transmit beams 715 and receive beams 720). In some examples, the base station 110 may transmit an indication of which UE transmit beam 715 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 715-A and the receive beam 720-A), which may be further refined and maintained in accordance with one or more established beam refinement procedures. An uplink beam, such as a UE transmit beam 715 or a receive beam 720, may be associated with a spatial relation. A spatial relation may indicate a directionality or a characteristic of the uplink beam, similar to one or more QCL properties, as described above.

3GPP standards Release 17 established a unified TCI state framework in which a TCI state may be used to indicate more than one beam. The TCI state may be used to indicate beams for a downlink channel or reference signal (RS) and/or an uplink channel or RS. There may be multiple types of unified TCI states. For example, a joint downlink/uplink common TCI state may indicate a common beam for at least one downlink channel or RS and at least one uplink channel or RS. This may be Type 1 and may include at least a UE-specific PDCCH, PDSCH, physical uplink control channel (PUCCH), and physical uplink shared channel (PUSCH). A separate downlink common TCI state may indicate a common beam for more than one downlink channel or RS. This may be Type 2 and may include at least a UE-specific PDCCH and PDSCH. A separate uplink common TCI state may indicate a common beam for more than one uplink channel or RS. This may be Type 3 and may include at least a UE-specific PUCCH and PUSCH. Other types of unified TCI states may include a separate downlink single channel or RS TCI state that indicates a beam for a single downlink channel or RS, a separate uplink single channel or RS TCI state that indicates a beam for a single uplink channel or RS, or an uplink spatial relation information, such as a spatial relation indicator (SRI), that indicates a beam for a single uplink channel or RS.

A network entity may transmit a unified TCI state indication that indicates a unified TCI state. The unified TCI state indication may provide, for a downlink or a joint TCI state, QCL-Type1 (e.g., for QCL-Type A) and QCL-Type2 (e.g., for QCL-Type D). The unified TCI state indication may also provide, for a downlink or a joint TCI state, power control parameters, such as a P0 value, an alpha value, or cross-link interference (CLI) information. For a joint TCI state, the unified TCI state indication may indicate a path loss RS. For an uplink TCI state, the unified TCI state indication may indicate an RS (e.g., for a spatial filter) and/or power control parameters.

As indicated above, FIG. 7 is provided as an example. Other examples may differ from what is described with respect to FIG. 7.

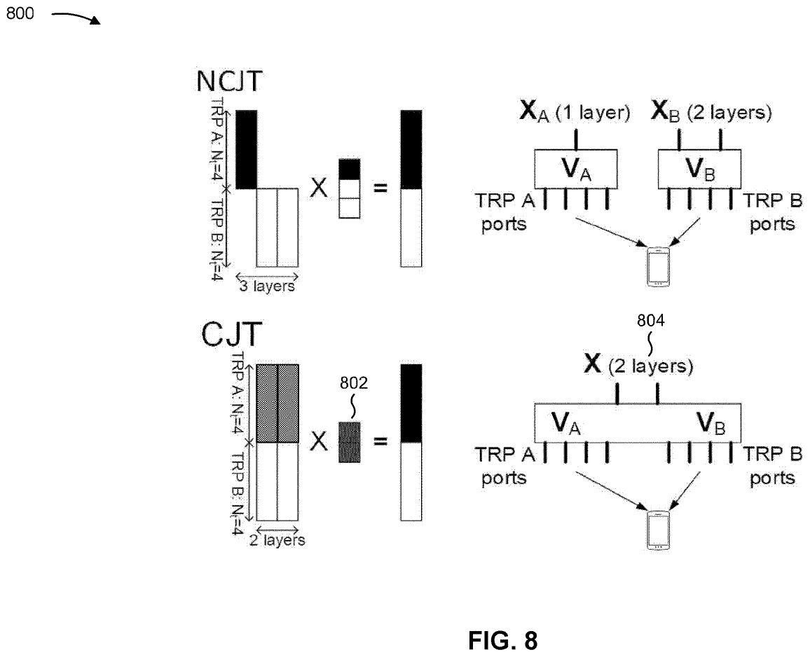

FIG. 8 is a diagram illustrating an example 800 of CJT and non-CJT (NCJT) for multiple TRPs, in accordance with the present disclosure.

CJT involves multiple transmitters that each transmit a message with a phase that is constructively combined at a receiver. CJT may include beamforming with antennas that are not co-located and that correspond to different TRPs. CJT may improve the signal power and spatial diversity of communications in an NR network.

For NCJT that is based on spatial domain multiplexing (SDM), data is precoded separately on different TRPs. For example, precoder A is precoded for one TRP, and precoder B is precoded for a separate TRP. This may be expressed as:

$$[ \begin{matrix}{V}_{A} & 0 \\ 0 & {V}_{B}\end{matrix} ] [ \begin{matrix}{X}_{A} \\ {X}_{B}\end{matrix} ] = [ \begin{matrix}{V}_{A} {X}_{A} \\ {V}_{B} {X}_{B}\end{matrix} ] ,$$

where letters not in bold are for precoder A and data for a first TRP, and letters in bold are for precoder B and data for a second TRP. For example, precoder

$$( {N}_{t}^{TRP} \times {RI}^{TRP} ) {V}_{A} : 4 \times 1 , {V}_{B} : 4 \times 2$$

may indicate a precoder for a specific TRP and rank (indicated by rank indicator (RI)). Data (RI^{TRP}×1) X_{A}: 1×1, X_{B}: 2×1 may indicate data by TRP and RI.

For CJT, data is precoded jointly on different TRPs. This may be expressed, for example, as:

$$[ \begin{matrix}{V}_{A} \\ {V}_{B}\end{matrix} ] \cdot X = [ \begin{matrix}{V}_{A} X \\ {V}_{B} X\end{matrix} ] , precoder ( {N}_{t}^{TRP} \times {RI}^{CJ} ) {V}_{A} : 4 \times 2 , {V}_{B} : 4 \times 2 ,$$

and data (RI^{CJT}×1) X: 2×1. Reference number 802 shows joint precoding for multiple TRPs rather than separate precoding as shown for NCJT. Reference number 804 shows two layers that are jointly precoded.

As indicated above, FIG. 8 is provided as an example. Other examples may differ from what is described with regard to FIG. 8.

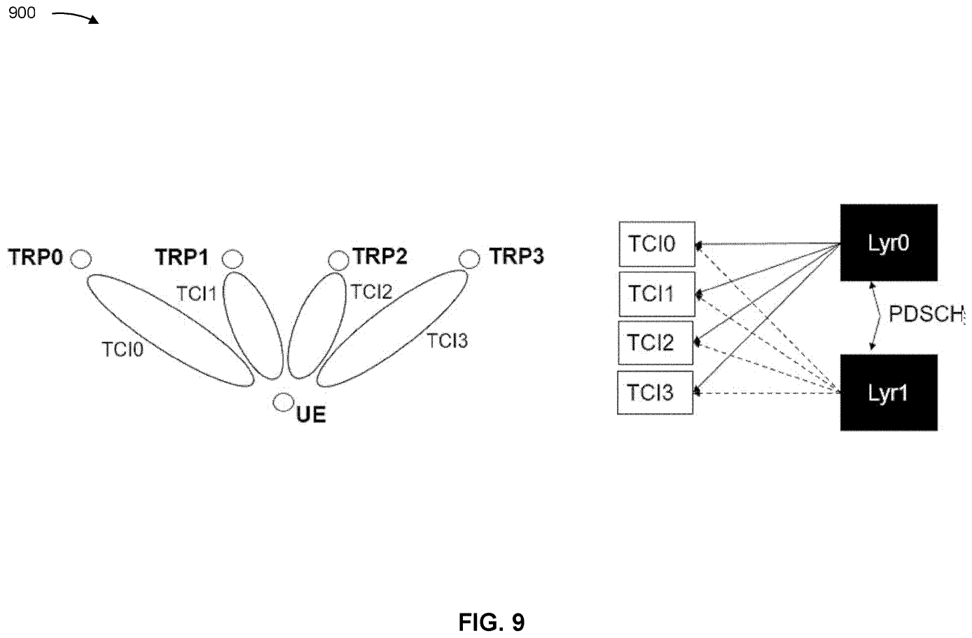

FIG. 9 is a diagram illustrating an example 900 of CJT for a PDSCH, in accordance with the present disclosure.

Example 900 shows multiple TCI states that can be used for multiple beams to receive physical downlink channel (e.g., PDSCH or PDCCH) communications from multiple TRPs in multiple TRP (mTRP) operation. For example, a UE may use CJT for receiving a PDSCH on one or more of the multiple beams, where the UE uses multiple TCI states for each layer.

A network entity may indicate up to X unified TCI states for communications on the PDSCH, where each layer or DMRS antenna port of the PDSCH is received at the UE using multiple indicated unified TCI states. In mTRP operation, the UE may be configured for CJT operations for the PDSCH, where X>2 TCI states are applied to each layer of the PDSCH. The UE may also be configured for SFN operations for a PDCCH, where two TCI states are applied to a CORESET receiving the PDCCH. However, the UE does not have clear information about how to use TCI states and dynamically switch TRPs in mTRP operation for the PDCCH and the PDSCH when CJT is involved for multiple TRPs. Without such clarity, beam selection may be suboptimal and communications can degrade, which wastes power, processing resources, and signaling resources.

As indicated above, FIG. 9 is provided as an example. Other examples may differ from what is described with regard to FIG. 9.

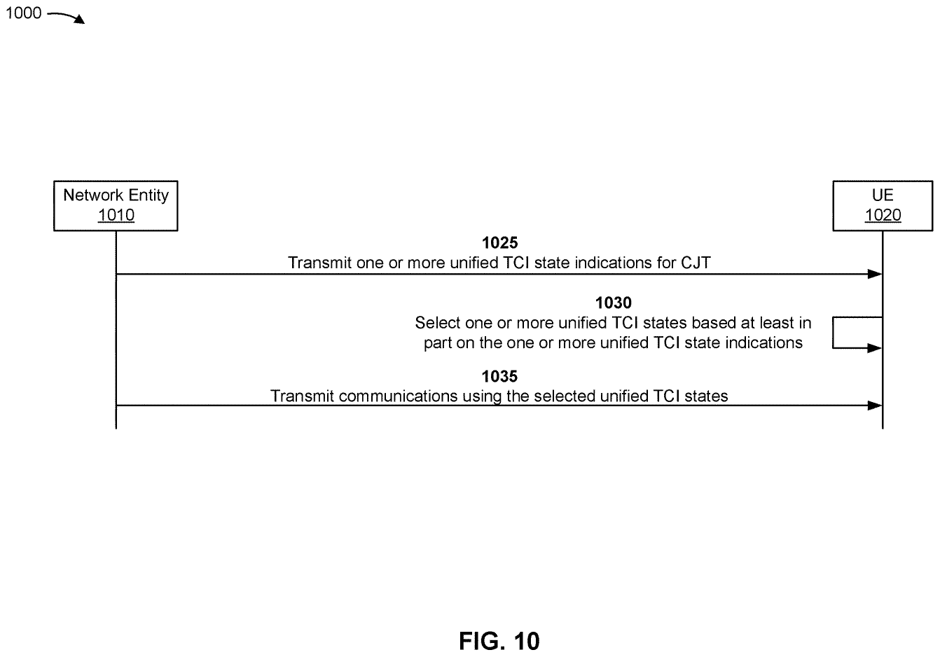

FIG. 10 is a diagram illustrating an example 1000 of indicating TCI states for CJT with multiple TRPs, in accordance with the present disclosure. Example 1000 shows a network entity 1010 (e.g., base station 110) and a UE 1020 (e.g., UE 120) that may communicate with each other via a wireless network (e.g., wireless network 100). The network entity 1010 may control or operate with one or more TRPs.

According to various aspects described herein, a network entity may transmit unified TCI state indications for CJT operations with more than two unified TCI states per layer of a PDSCH, where a UE is configured for an SFN operation (e.g., communication in an SFN) for a PDCCH that applies two TCI states to a CORESET that receives the PDCCH. The UE may select unified TCI states and receive communications using the selected unified TCI states. In this way, the UE may select unified TCI states for CJT with multiple TRPs for more accurate and efficient communications, which conserves power, processing resources, and signaling resources.

Example 1000 shows a process of using unified TCI state indications that provide more information to the UE 1020 for selecting unified TCI states when the UE 1020 is enabled with CJT operations for a PDSCH, where X>2 unified TCI states are applied to each layer of the PDSCH, and when the UE 1020 is enabled with SFN operation for the PDCCH, where two TCI states are applied to a CORESET receiving the PDCCH.

As shown by reference number 1025, the network entity 1010 may transmit one or more unified TCI state indications for CJT operations with more than two unified TCI states per layer of a PDSCH. A unified TCI state indication may include information (e.g., in a TCI codepoint) that indicates a unified TCI state. As shown by reference number 1030, the UE 1020 may select one or more unified TCI states for physical downlink control channel (e.g., PDCCH, PDSCH) communications based at least in part on the one or more unified TCI state indications. As shown by reference number 1035, the network entity 1010 may transmit physical downlink channel communications using the selected unified TCI states.

In some aspects, the network entity 1010 may transmit unified TCI state indications for X unified TCI states (joint or downlink TCI states), where the unified TCI state indications are included in a single TCI codepoint. The UE 1020 may apply the X unified TCI states to each layer of the PDSCH and apply two unified TCI states from the X unified TCI state indications to the PDCCH. For example, the UE 1020 may select two unified TCI states associated with the CORESET based at least in part on a default order, such as the first two unified TCI states of the X unified TCI states indicated in the TCI codepoint. The UE 1020 may also select two unified TCI states based at least in part on a flag configuration. For example, the network entity 1010 may transmit an RRC flag that includes a TRP identifier (ID) associated with a TCI state or the CORESET. This may include a first TCI state and a second TCI state that share the RRC flag for the CORESET.

In some aspects, the network entity 1010 may indicate the X unified TCI states in two or more TCI codepoints. For example, the network entity 1010 may indicate two unified TCI states in a first TCI codepoint and X-2 unified TCI states in a second TCI codepoint (if X>2). The SFN CORESET may use the unified TCI states from the first TCI codepoint. Each layer of the CJT PDSCH may use the unified TCI states from both the first TCI codepoint and the second TCI codepoint. The first TCI codepoint and the second TCI codepoint may be indicated by a single DCI or two separate DCIs, where one DCI may indicate the TCI codepoint used for the PDSCH (e.g., only the PDSCH). The first TCI codepoint and the second TCI codepoint may be activated by the same TCI activation MAC CE or by two separate TCI activation MAC CEs, where one MAC CE may activate the TCI codepoint used for the PDSCH (e.g., only the PDSCH).

As indicated above, FIG. 10 is provided as an example. Other examples may differ from what is described with regard to FIG. 10.

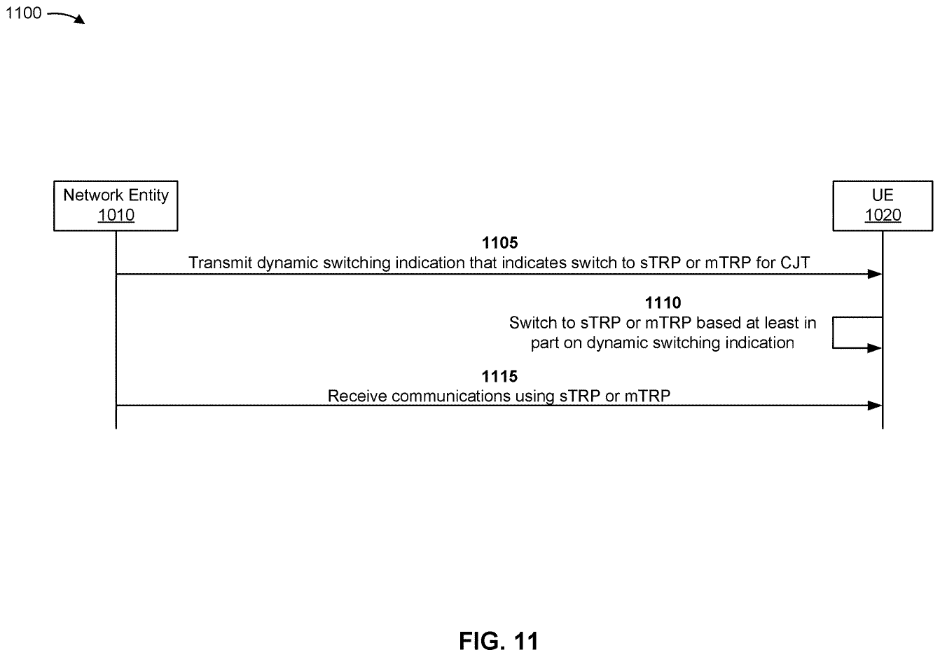

FIG. 11 is a diagram illustrating an example 1100 of indicating a switch to a single TRP operation or a multi-TRP operation, in accordance with the present disclosure.

In some aspects, the UE 1020 may be configured for CJT operations for a PDSCH, where X>2 unified TCI states are applied to each layer of the PDSCH. The UE 1020 may be further configured for an SFN operation for the PDCCH where two unified TCI states are applied to a CORESET receiving the PDCCH. The UE may be configured for dynamic multi-TRP switching to specify single TRP (sTRP) or multi-TRP (mTRP) operations.

Example 1100 shows the UE 1020 receiving and using a dynamic switching indication. As shown by reference number 1105, the network entity 1010 may transmit a dynamic switching indication (e.g., DCI, MAC CE) that indicates a switch to an sTRP operation or an mTRP operation for CJT operations with more than two unified TCI states per layer of a PDSCH, where the UE 1020 is configured for an SFN operation for a PDCCH that applies two TCIs to a CORESET that receives the PDCCH. The sTRP operation may include receiving communications from a single TRP. The mTRP operation may include receiving communications from multiple TRPs, including using CJT. The network entity 1010 may transmit the dynamic switching indication using a specific TCI codepoint reserved for dynamic switching indications. The network entity 1010 may transmit the dynamic switching indication in DCI scheduling the CJT PDSCH. Alternatively, the network entity 1010 may transmit the dynamic switching indication in either the DCI scheduling the CJT PDSCH or in DCI not scheduling the CJT PDSCH.

As shown by reference number 1110, the UE 1020 may switch to the sTRP operation or the mTRP operation based at least in part on the dynamic switching indication. As shown by reference number 1115, the UE 1020 may receive communications (e.g., PDSCH, PDCCH) in the sTRP operation or the mTRP operation.

In some aspects, the dynamic switching indication may be common for the PDCCH and the PDSCH. The dynamic switching indication may be valid for a period of time (“sticky” indication) or for one time instance.

In some aspects, the dynamic switching indication may be separate for the PDCCH and the PDSCH. For example, the dynamic switching indication may be valid for a time period for the PDCCH (e.g., only for the PDCCH), valid for one time instance for the PDCCH, valid for a time period for the PDSCH, valid for one time instance for the PDSCH, or any combination thereof.

In some aspects, the dynamic switching indication may indicate whether sTRP or mTRP is to be applied for the PDCCH and/or the PDSCH. The dynamic switching indication may indicate a subset of TRPs (from among the multiple TRPs) that are used for the PDCCH and/or the PDSCH. In some aspects, the UE 1020 may apply one or more unified TCI states based at least in part on the quantity of TRPs. For example, for sTRP operation, the UE 1020 may apply TCI1, TCI1, TCI3, or TCI4. For two TRPs for the PDCCH or the PDSCH, the UE 1020 may apply any of (TCI1, TCI2), (TCI1, TCI3), (TCI1, TCI4), (TCI2, TCI3), (TCI2, TCI4), or (TCI3, TCI4). For three TRPs for the PDSCH, the UE 1020 may apply (TCI1, TCI2, TCI3), (TCI1, TCI2, TCI4), (TCI1, TCI3, TCI4), or (TCI2, TCI3, TCI4).

By using a dynamic switching indication for CJT PDSCH and/or PDCCH, the UE 1020 may have more flexibility and may be more efficient when multiple TRPs can be involved. As a result, communications improve and thus the network entity 1010 and the UE 1020 conserve power, processing resources, and signaling resources.

As indicated above, FIG. 11 is provided as an example. Other examples may differ from what is described with regard to FIG. 11.

FIG. 12 is a diagram illustrating an example process 1200 performed, for example, by a UE, in accordance with the present disclosure. Example process 1200 is an example where the UE (e.g., UE 120, UE 1020) performs operations associated with receiving unified TCI state indications for CJT.

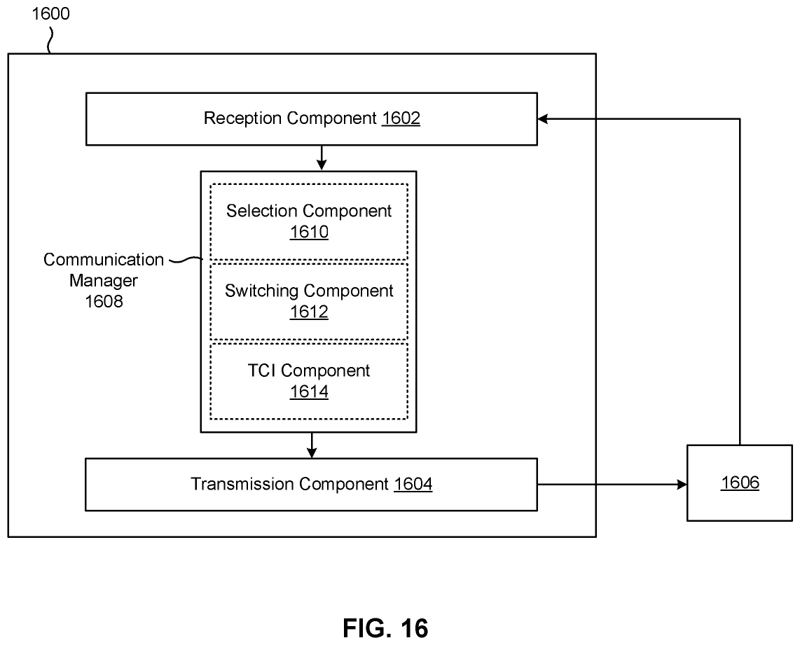

As shown in FIG. 12, in some aspects, process 1200 may include receiving one or more unified TCI state indications for CJT operations with more than two unified TCI states per layer of a PDSCH, where the UE is configured for an SFN operation for a PDCCH that applies two TCI states to a CORESET that receives the PDCCH (block 1210). For example, the UE (e.g., using communication manager 1608 and/or reception component 1602 depicted in FIG. 16) may receive one or more unified TCI state indications for CJT operations with more than two unified TCI states per layer of a PDSCH, where the UE is configured for an SFN operation for a PDCCH that applies two TCI states to a CORESET that receives the PDCCH, as described above.

As further shown in FIG. 12, in some aspects, process 1200 may include selecting one or more unified TCI states for one or more physical downlink channel communications based at least in part on the one or more unified TCI state indications (block 1220). For example, the UE (e.g., using communication manager 1608 and/or selection component 1610 depicted in FIG. 16) may select one or more unified TCI states for one or more physical downlink channel communications based at least in part on the one or more unified TCI state indications, as described above.

As further shown in FIG. 12, in some aspects, process 1200 may include receiving the one or more physical downlink channel communications using the selected one or more unified TCI states (block 1230). For example, the UE (e.g., using communication manager 1608 and/or reception component 1602 depicted in FIG. 16) may receive the one or more physical downlink channel communications using the selected one or more unified TCI states, as described above.

Process 1200 may include additional aspects, such as any single aspect or any combination of aspects described below and/or in connection with one or more other processes described elsewhere herein.

In a first aspect, a single codepoint indicates the more than two unified TCI states.

In a second aspect, alone or in combination with the first aspect, process 1200 includes applying the more than two unified TCI states to each layer of the PDSCH and two of the more than two unified TCI states to the PDCCH.

In a third aspect, alone or in combination with one or more of the first and second aspects, selecting the one or more unified TCI states includes selecting two TCI states associated with the CORESET based at least in part on a default order.

In a fourth aspect, alone or in combination with one or more of the first through third aspects, the default order includes a first unified TCI state and a second unified TCI state in the single codepoint.

In a fifth aspect, alone or in combination with one or more of the first through fourth aspects, selecting the one or more unified TCI states includes selecting two TCI states based at least in part on a flag configuration.

In a sixth aspect, alone or in combination with one or more of the first through fifth aspects, the flag configuration includes an RRC flag that includes a TRP identifier associated with a TCI state or the CORESET.

In a seventh aspect, alone or in combination with one or more of the first through sixth aspects, a first TCI state and a second TCI state share the RRC flag for the CORESET.

In an eighth aspect, alone or in combination with one or more of the first through seventh aspects, a first codepoint and a second codepoint indicate the more than two unified TCI states.

In a ninth aspect, alone or in combination with one or more of the first through eighth aspects, the first codepoint indicates two unified TCI states of the more than two unified TCI states and the second codepoint indicates unified TCI states other than the two unified TCI states.

In a tenth aspect, alone or in combination with one or more of the first through ninth aspects, the CORESET uses the two unified TCI states from the first codepoint.

In an eleventh aspect, alone or in combination with one or more of the first through tenth aspects, process 1200 includes applying the two unified TCI states indicated by the first codepoint and the other unified TCI states indicated by the second codepoint to each layer of the PDSCH.

In a twelfth aspect, alone or in combination with one or more of the first through eleventh aspects, a single DCI indicates the first codepoint and the second codepoint.

In a thirteenth aspect, alone or in combination with one or more of the first through twelfth aspects, a first DCI indicates the first codepoint and a second DCI indicates the second codepoint, and the first DCI or the second DCI indicates a TCI codepoint used for PDSCH.

In a fourteenth aspect, alone or in combination with one or more of the first through thirteenth aspects, process 1200 includes receiving a MAC CE that activates both the first codepoint and the second codepoint.

In a fifteenth aspect, alone or in combination with one or more of the first through fourteenth aspects, process 1200 includes receiving a first MAC CE that activates the first codepoint, and receiving a second MAC CE that activates the second codepoint.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network entity, in accordance with the present disclosure. Example process 1300 is an example where the network entity (e.g., base station 110, network entity 1010) performs operations associated with indicating unified TCI states for CJT.

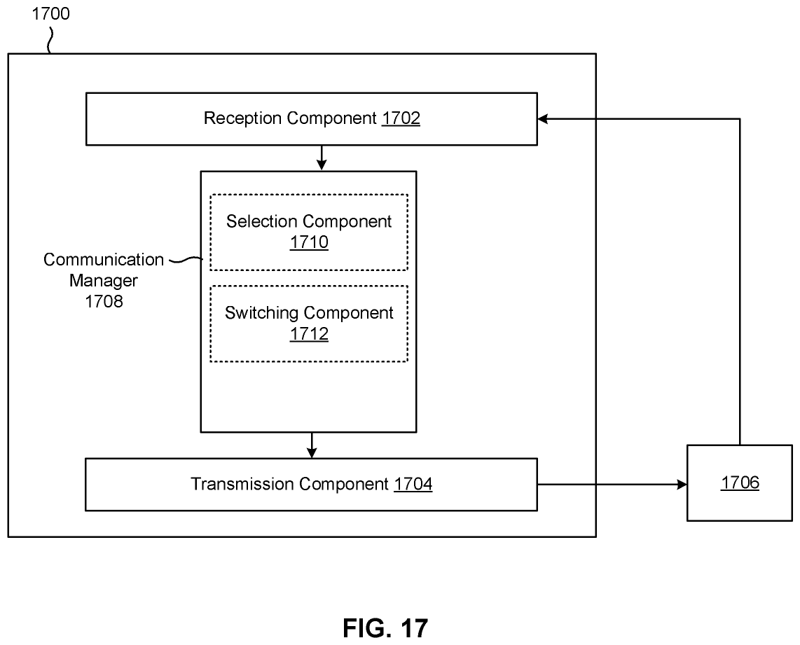

As shown in FIG. 13, in some aspects, process 1300 may include transmitting one or more unified TCI state indications for CJT operations with more than two unified TCI states per layer of a PDSCH, where the one or more unified TCI state indications are associated with a configuration for an SFN operation for a PDCCH that applies two TCIs to a CORESET that receives the PDCCH (block 1310). For example, the network entity (e.g., using communication manager 1708 and/or transmission component 1704 depicted in FIG. 17) may transmit one or more unified TCI state indications for CJT operations with more than two unified TCI states per layer of a PDSCH, where the one or more unified TCI state indications are associated with a configuration for an SFN operation for a PDCCH that applies two TCIs to a CORESET that receives the PDCCH, as described above.

As further shown in FIG. 13, in some aspects, process 1300 may include selecting one or more unified TCI states for one or more physical downlink channel communications based at least in part on the one or more unified TCI state indications (block 1320). For example, the network entity (e.g., using communication manager 1708 and/or selection component 1710 depicted in FIG. 17) may select one or more unified TCI states for one or more physical downlink channel communications based at least in part on the one or more unified TCI state indications, as described above.

As further shown in FIG. 13, in some aspects, process 1300 may include transmitting one or more physical downlink channel communications using the selected one or more unified TCI states (block 1330). For example, the network entity (e.g., using communication manager 1708 and/or transmission component 1704 depicted in FIG. 17) may transmit one or more physical downlink channel communications using the selected one or more unified TCI states, as described above.

Process 1300 may include additional aspects, such as any single aspect or any combination of aspects described below and/or in connection with one or more other processes described elsewhere herein.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 120, UE 1020) performs operations associated with receiving unified TCI state indications for CJT.

As shown in FIG. 14, in some aspects, process 1400 may include receiving a dynamic switching indication that indicates a switch to a single TRP operation or a multiple TRP operation for CJT operations with more than two unified TCI states per layer of a PDSCH, where the UE is configured for an SFN operation for a PDCCH that applies two TCIs to a CORESET that receives the PDCCH (block 1410). For example, the UE (e.g., using communication manager 1608 and/or reception component 1602 depicted in FIG. 16) may receive a dynamic switching indication that indicates a switch to a single TRP operation or a multiple TRP operation for CJT operations with more than two unified TCI states per layer of a PDSCH, where the UE is configured for an SFN operation for a PDCCH that applies two TCIs to a CORESET that receives the PDCCH, as described above.

As further shown in FIG. 14, in some aspects, process 1400 may include switching to the single TRP operation or the multiple TRP operation based at least in part on the dynamic switching indication (block 1420). For example, the UE (e.g., using communication manager 1608 and/or switching component 1612 depicted in FIG. 16) may switch to the single TRP operation or the multiple TRP operation based at least in part on the dynamic switching indication, as described above.

Process 1400 may include additional aspects, such as any single aspect or any combination of aspects described below and/or in connection with one or more other processes described elsewhere herein.

In a first aspect, the dynamic switching indication is common for the PDCCH and the PDSCH.

In a second aspect, alone or in combination with the first aspect, the dynamic switching indication is valid for a period of time.

In a third aspect, alone or in combination with one or more of the first and second aspects, the dynamic switching indication is valid for a single instance.

In a fourth aspect, alone or in combination with one or more of the first through third aspects, the dynamic switching indication is separate for the PDCCH and the PDSCH.

In a fifth aspect, alone or in combination with one or more of the first through fourth aspects, the dynamic switching indication is valid for one or more of a period of time for the PDCCH, a time instance for the PDCCH, a period of time for the PDSCH, a time instance for the PDSCH, or any combination thereof.

In a sixth aspect, alone or in combination with one or more of the first through fifth aspects, the dynamic switching indication indicates the single TRP operation or the multiple TRP operation for one or more of the PDCCH or the PDSCH.

In a seventh aspect, alone or in combination with one or more of the first through sixth aspects, the dynamic switching indication indicates one or more of a subset of TRPs used for the PDCCH or a subset of TRPs used for the PDSCH.

In an eighth aspect, alone or in combination with one or more of the first through seventh aspects, the dynamic switching indication indicates the multiple TRP operation, and the dynamic switching indication is dedicated to switching to the multiple TRP operation.

In a ninth aspect, alone or in combination with one or more of the first through eighth aspects, the dynamic switching indication indicates the multiple TRP operation, and the dynamic switching indication includes a codepoint dedicated to switching to the multiple TRP operation.

In a tenth aspect, alone or in combination with one or more of the first through ninth aspects, the dynamic switching indication is for CJT PDSCH and is included in scheduling downlink control information.

In an eleventh aspect, alone or in combination with one or more of the first through tenth aspects, the dynamic switching indication is for CJT PDSCH and is configured to be included in scheduling DCI or in DCI that is not scheduling for CJT PDSCH.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network entity, in accordance with the present disclosure. Example process 1500 is an example where the network entity (e.g., base station 110, network entity 1010) performs operations associated with indicating unified TCI states for CJT.

As shown in FIG. 15, in some aspects, process 1500 may include transmitting a dynamic switching indication that indicates a switch to a single TRP operation or a multiple TRP operation for CJT operations with more than two unified TCI states per layer of a PDSCH, where the dynamic switching indication is associated with a configuration for an SFN operation for a PDCCH that applies two TCIs to a CORESET that receives the PDCCH (block 1510). For example, the network entity (e.g., using communication manager 1708 and/or transmission component 1704 depicted in FIG. 17) may transmit a dynamic switching indication that indicates a switch to a single TRP operation or a multiple TRP operation for CJT operations with more than two unified TCI states per layer of a PDSCH, where the dynamic switching indication is associated with a configuration for an SFN operation for a PDCCH that applies two TCIs to a CORESET that receives the PDCCH, as described above.

As further shown in FIG. 15, in some aspects, process 1500 may include switching to the single TRP operation or the multiple TRP operation based at least in part on the dynamic switching indication (block 1520). For example, the network entity (e.g., using communication manager 1708 and/or switching component 1712 depicted in FIG. 17) may switch to the single TRP operation or the multiple TRP operation based at least in part on the dynamic switching indication, as described above.

Process 1500 may include additional aspects, such as any single aspect or any combination of aspects described below and/or in connection with one or more other processes described elsewhere herein.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE (e.g., UE 120, UE 1020), or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 1608. The communication manager 1608 may control and/or otherwise manage one or more operations of the reception component 1602 and/or the transmission component 1604. In some aspects, the communication manager 1608 may include one or more antennas, a modem, a controller/processor, a memory, or a combination thereof, of the UE described in connection with FIG. 2. The communication manager 1608 may be, or be similar to, the communication manager 140 depicted in FIGS. 1 and 2. For example, in some aspects, the communication manager 1608 may be configured to perform one or more of the functions described as being performed by the communication manager 140. In some aspects, the communication manager 1608 may include the reception component 1602 and/or the transmission component 1604. The communication manager 1608 may include a selection component 1610, a switching component 1612, and/or a TCI component 1614, among other examples.

In some aspects, the apparatus 1600 may be configured to perform one or more operations described herein in connection with FIGS. 1-11. Additionally, or alternatively, the apparatus 1600 may be configured to perform one or more processes described herein, such as process 1200 of FIG. 12, process 1400 of FIG. 14, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

In some aspects, the reception component 1602 may receive one or more unified TCI state indications for CJT operations with more than two unified TCI states per layer of a PDSCH, where the UE is configured for an SFN operation for a PDCCH that applies two TCI states to a CORESET that receives the PDCCH. The selection component 1610 may select one or more unified TCI states for one or more physical downlink channel communications based at least in part on the one or more unified TCI state indications. The reception component 1602 may receive the one or more physical downlink channel communications using the selected one or more unified TCI states.

The TCI component 1614 may apply the more than two unified TCI states to each layer of the PDSCH and two of the more than two unified TCI states to the PDCCH. The TCI component 1614 may apply the two unified TCI states indicated by the first codepoint and the other unified TCI states indicated by the second codepoint to each layer of the PDSCH.

The reception component 1602 may receive a MAC CE that activates both the first codepoint and the second codepoint. The reception component 1602 may receive a first MAC CE that activates the first codepoint. The reception component 1602 may receive a second MAC CE that activates the second codepoint.

In some aspects, the reception component 1602 may receive a dynamic switching indication that indicates a switch to a single TRP operation or a multiple TRP operation for CJT operations with more than two unified TCI states per layer of a PDSCH, where the UE is configured for an SFN operation for a PDCCH that applies two TCIs to a CORESET that receives the PDCCH. The switching component 1612 may switch to the single TRP operation or the multiple TRP operation based at least in part on the dynamic switching indication.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network entity (e.g., base station 110, network entity 1010), or a network entity may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 1708. The communication manager 1708 may control and/or otherwise manage one or more operations of the reception component 1702 and/or the transmission component 1704. In some aspects, the communication manager 1708 may include one or more antennas, a modem, a controller/processor, a memory, or a combination thereof, of the network entity described in connection with FIG. 2. The communication manager 1708 may be, or be similar to, the communication manager 150 depicted in FIGS. 1 and 2. For example, in some aspects, the communication manager 1708 may be configured to perform one or more of the functions described as being performed by the communication manager 150. In some aspects, the communication manager 1708 may include the reception component 1702 and/or the transmission component 1704. The communication manager 1708 may include a selection component 1710 and/or a switching component 1712, among other examples.

In some aspects, the apparatus 1700 may be configured to perform one or more operations described herein in connection with FIGS. 1-11. Additionally, or alternatively, the apparatus 1700 may be configured to perform one or more processes described herein, such as process 1300 of FIG. 13, process 1500 of FIG. 15, or a combination thereof. In some aspects, the apparatus 1700 and/or one or more components shown in FIG. 17 may include one or more components of the network entity described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network entity described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the network entity described in connection with FIG. 2. In some aspects, the transmission component 1704 may be co-located with the reception component 1702 in a transceiver.

In some aspects, the transmission component 1704 may transmit one or more unified TCI state indications for CJT operations with more than two unified TCI states per layer of a PDSCH, where the one or more unified TCI state indications are associated with a configuration for an SFN operation for a PDCCH that applies two TCIs to a CORESET that receives the PDCCH. The selection component 1710 may select one or more unified TCI states for one or more physical downlink channel communications based at least in part on the one or more unified TCI state indications. The transmission component 1704 may transmit one or more physical downlink channel communications using the selected one or more unified TCI states.

In some aspects, the transmission component 1704 may transmit a dynamic switching indication that indicates a switch to a single TRP operation or a multiple TRP operation for CJT operations with more than two unified TCI states per layer of a PDSCH, where the dynamic switching indication is associated with a configuration for an SFN operation for a PDCCH that applies two TCIs to a CORESET that receives the PDCCH. The switching component 1712 may switch to the single TRP operation or the multiple TRP operation based at least in part on the dynamic switching indication.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: receiving one or more unified transmission configuration indicator (TCI) state indications for coherent joint transmission (CJT) operations with more than two unified TCI states per layer of a physical downlink shared channel (PDSCH), wherein the UE is configured for a single frequency network (SFN) operation for a physical downlink control channel (PDCCH) that applies two TCI states to a control resource set (CORESET) that receives the PDCCH; selecting one or more unified TCI states for one or more physical downlink channel communications based at least in part on the one or more unified TCI state indications; and receiving the one or more physical downlink channel communications using the selected one or more unified TCI states.

Aspect 2: The method of Aspect 1, wherein a single codepoint indicates the more than two unified TCI states.

Aspect 3: The method of Aspect 2, further comprising applying the more than two unified TCI states to each layer of the PDSCH and two of the more than two unified TCI states to the PDCCH.

Aspect 4: The method of Aspect 2 or 3, wherein selecting the one or more unified TCI states includes selecting two TCI states associated with the CORESET based at least in part on a default order.

Aspect 5: The method of Aspect 4, wherein the default order includes a first unified TCI state and a second unified TCI state in the single codepoint.

Aspect 6: The method of Aspect 2, wherein selecting the one or more unified TCI states includes selecting two TCI states based at least in part on a flag configuration.

Aspect 7: The method of Aspect 6, wherein the flag configuration includes a radio resource control (RRC) flag that includes a transmit receive point (TRP) identifier associated with a TCI state or the CORESET.

Aspect 8: The method of Aspect 7, wherein a first TCI state and a second TCI state share the RRC flag for the CORESET.

Aspect 9: The method of any of Aspects 1-4 and 5-8, wherein a first codepoint and a second codepoint indicate the more than two unified TCI states.

Aspect 10: The method of Aspect 9, wherein the first codepoint indicates two unified TCI states of the more than two unified TCI states and the second codepoint indicates unified TCI states other than the two unified TCI states.

Aspect 11: The method of Aspect 9 or 10, wherein the CORESET uses the two unified TCI states from the first codepoint.

Aspect 12: The method of any of Aspects 9-11, further comprising applying the two unified TCI states indicated by the first codepoint and the other unified TCI states indicated by the second codepoint to each layer of the PDSCH.

Aspect 13: The method of any of Aspects 9-12, wherein a single downlink control information indicates the first codepoint and the second codepoint.

Aspect 14: The method of any of Aspects 9-12, wherein a first downlink control information (DCI) indicates the first codepoint and a second DCI indicates the second codepoint, and wherein the first DCI or the second DCI indicates a TCI codepoint used for PDSCH.

Aspect 15: The method of any of Aspects 9-14, further comprising receiving a medium access control control element (MAC CE) that activates both the first codepoint and the second codepoint.

Aspect 16: The method of any of Aspects 9-14, further comprising: receiving a first medium access control control element (MAC CE) that activates the first codepoint; and receiving a second MAC CE that activates the second codepoint.

Aspect 17: A method of wireless communication performed by a network entity, comprising: transmitting one or more unified transmission configuration indicator (TCI) state indications for coherent joint transmission (CJT) operations with more than two unified TCI states per layer of a physical downlink shared channel (PDSCH), wherein the one or more unified TCI state indications are associated with a configuration for a single frequency network (SFN) operation for a physical downlink control channel (PDCCH) that applies two TCIs to a control resource set (CORESET) that receives the PDCCH; selecting one or more unified TCI states for one or more physical downlink channel communications based at least in part on the one or more unified TCI state indications; and transmitting one or more physical downlink channel communications using the selected one or more unified TCI states.

Aspect 18: A method of wireless communication performed by a user equipment (UE), comprising: receiving a dynamic switching indication that indicates a switch to a single transmit receive point (TRP) operation or a multiple TRP operation for coherent joint transmission (CJT) operations with more than two unified transmission configuration indicator (TCI) states per layer of a physical downlink shared channel (PDSCH), wherein the UE is configured for a single frequency network (SFN) operation for a physical downlink control channel (PDCCH) that applies two TCIs to a control resource set (CORESET) that receives the PDCCH; and switching to the single TRP operation or the multiple TRP operation based at least in part on the dynamic switching indication.

Aspect 19: The method of Aspect 18, wherein the dynamic switching indication is common for the PDCCH and the PDSCH.

Aspect 20: The method of Aspect 19, wherein the dynamic switching indication is valid for a period of time.

Aspect 21: The method of Aspect 19, wherein the dynamic switching indication is valid for a single instance.

Aspect 22: The method of any of Aspects 18-21, wherein the dynamic switching indication is separate for the PDCCH and the PDSCH.

Aspect 23: The method of Aspect 22, wherein the dynamic switching indication is valid for one or more of: a period of time for the PDCCH, a time instance for the PDCCH, a period of time for the PDSCH, a time instance for the PDSCH, or any combination thereof.

Aspect 24: The method of any of Aspects 18-23, wherein the dynamic switching indication indicates the single TRP operation or the multiple TRP operation for one or more of the PDCCH or the PDSCH.

Aspect 25: The method of any of Aspects 18-24, wherein the dynamic switching indication indicates one or more of a subset of TRPs used for the PDCCH or a subset of TRPs used for the PDSCH.

Aspect 26: The method of any of Aspects 18-25, wherein the dynamic switching indication indicates the multiple TRP operation, and wherein the dynamic switching indication is dedicated to switching to the multiple TRP operation.

Aspect 27: The method of any of Aspects 18-26, wherein the dynamic switching indication indicates the multiple TRP operation, and wherein the dynamic switching indication includes a codepoint dedicated to switching to the multiple TRP operation.

Aspect 28: The method of any of Aspects 18-27, wherein the dynamic switching indication is for CJT PDSCH and is included in scheduling downlink control information.

Aspect 29: The method of any of Aspects 18-27, wherein the dynamic switching indication is for CJT PDSCH and is configured to be included in scheduling downlink control information (DCI) or in DCI that is not scheduling for CJT PDSCH.

Aspect 30: A method of wireless communication performed by a network entity, comprising: transmitting a dynamic switching indication that indicates a switch to a single transmit receive point (TRP) operation or a multiple TRP operation for coherent joint transmission (CJT) operations with more than two unified transmission configuration indicator (TCI) states per layer of a physical downlink shared channel (PDSCH), wherein the dynamic switching indication is associated with a configuration for a single frequency network (SFN) operation for a physical downlink control channel (PDCCH) that applies two TCIs to a control resource set (CORESET) that receives the PDCCH; and switching to the single TRP operation or the multiple TRP operation based at least in part on the dynamic switching indication.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive one or more unified transmission configuration indicator (TCI) state indications for coherent joint transmission (CJT) operations with more than two unified TCI states per layer of a physical downlink shared channel (PDSCH), wherein the UE is configured for a single frequency network (SFN) operation for a physical downlink control channel (PDCCH) that applies two TCI states to a control resource set (CORESET) that receives the PDCCH;
select one or more unified TCI states for one or more physical downlink channel communications based at least in part on the one or more unified TCI state indications; and
receive the one or more physical downlink channel communications using the selected one or more unified TCI states.

2. The UE of claim 1, wherein a single codepoint indicates the more than two unified TCI states.

3. The UE of claim 2, wherein the one or more processors are configured to apply the more than two unified TCI states to each layer of the PDSCH and two of the more than two unified TCI states to the PDCCH.

4. The UE of claim 2, wherein the one or more processors, to select the one or more unified TCI states, are configured to select two TCI states associated with the CORESET based at least in part on a default order.

5. The UE of claim 4, wherein the default order includes a first unified TCI state and a second unified TCI state in the single codepoint.

6. The UE of claim 2, wherein the one or more processors, to select the one or more unified TCI states, are configured to select two TCI states based at least in part on a flag configuration.

7. The UE of claim 6, wherein the flag configuration includes a radio resource control (RRC) flag that includes a transmit receive point (TRP) identifier associated with a TCI state or the CORESET.

8. The UE of claim 7, wherein a first TCI state and a second TCI state share the RRC flag for the CORESET.

9. The UE of claim 1, wherein a first codepoint and a second codepoint indicate the more than two unified TCI states.

10. The UE of claim 9, wherein the first codepoint indicates two unified TCI states of the more than two unified TCI states and the second codepoint indicates unified TCI states other than the two unified TCI states.

11. (canceled)

12. The UE of claim 9, wherein the CORESET uses the two unified TCI states from the first codepoint.

13-15. (canceled)

16. The UE of claim 9, wherein the one or more processors are configured to:
receive a first medium access control control element (MAC CE) that activates the first codepoint; and
receive a second MAC CE that activates the second codepoint.

17. A network entity for wireless communication, comprising:
a memory; and
one or more processors, coupled to the memory, configured to:
transmit one or more unified transmission configuration indicator (TCI) state indications for coherent joint transmission (CJT) operations with more than two unified TCI states per layer of a physical downlink shared channel (PDSCH), wherein the one or more unified TCI state indications are associated with a configuration for a single frequency network (SFN) operation for a physical downlink control channel (PDCCH) that applies two TCIs to a control resource set (CORESET) that receives the PDCCH;
select one or more unified TCI states for one or more physical downlink channel communications based at least in part on the one or more unified TCI state indications; and
transmit one or more physical downlink channel communications using the selected one or more unified TCI states.

18. A user equipment (UE) for wireless communication, comprising:
a memory; and
one or more processors, coupled to the memory, configured to:
receive a dynamic switching indication that indicates a switch to a single transmit receive point (TRP) operation or a multiple TRP operation for coherent joint transmission (CJT) operations with more than two unified transmission configuration indicator (TCI) states per layer of a physical downlink shared channel (PDSCH), wherein the UE is configured for a single frequency network (SFN) operation for a physical downlink control channel (PDCCH) that applies two TCIs to a control resource set (CORESET) that receives the PDCCH; and
switch to the single TRP operation or the multiple TRP operation based at least in part on the dynamic switching indication.

19. The UE of claim 18, wherein the dynamic switching indication is common for the PDCCH and the PDSCH.

20. The UE of claim 19, wherein the dynamic switching indication is valid for a period of time.

21. The UE of claim 19, wherein the dynamic switching indication is valid for a single instance.

22. The UE of claim 18, wherein the dynamic switching indication is separate for the PDCCH and the PDSCH.

23. The UE of claim 22, wherein the dynamic switching indication is valid for one or more of:
a period of time for the PDCCH,
a time instance for the PDCCH,
a period of time for the PDSCH,
a time instance for the PDSCH, or
any combination thereof.

24. The UE of claim 18, wherein the dynamic switching indication indicates the single TRP operation or the multiple TRP operation for one or more of the PDCCH or the PDSCH.

25-30. (canceled)
